(19) United States
(12) Patent Application Publication
(10) Pub. No.: US 2005/0006290 A1
(43) Pub. Date: Jan. 13, 2005

(54) Mobile biodiesel refinery

(76) Inventor: J. P. Patten, Orlando, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/862,051

(22) Filed: Jun. 4, 2004

Related U.S. Application Data
(60) Provisional application No. 60/476,064, filed on Jun. 5, 2003.

(51) Int. Cl. B01J 20/00

(52) U.S. Cl. 210/198.1

(57) ABSTRACT

This is a computer controlled and automated mobile and/or static process to reclaim used waste fryer oil used for cooking and convert it into biodiesel. The waste, which can contain many contaminants including food particles, and water and emulsified or congealed grease, is forcibly vacuumed into a container and heated. Contaminates are removed by passing the heated fluid via a strainer. Once determined clean by the computer, the fluid travels out of the vessel through the strainer and back into the vessel. Any water settles to the bottom of the heated chamber. As the computer senses the presence of water, it is removed via a drain. The grease is then pumped to a second chamber and treated with a titrated amount of catalyst, as determined by sensors and software. After reaction takes place, glycerin levels are monitored and removed via a strainer, and the fluid is pumped to the next chamber. pH is measured by the computer and balanced. It is processed in a final wash to remove any remaining impurities. The product is tested for standards via sensors and software and then is moved to the delivery tank through a filter. Upon reaching the delivery site, the biodiesel is pumped and measured from the delivery vessel through a final filter to the customer's tank. Unless the computer notices a failure of one of the modular components, the truck is periodically sent to a maintenance facility for replenishment of catalyst and removal of food particles or other contaminates. In the case of failure the driver is immediately notified by the computer, and the truck is directed to the nearest service center. This system is monitored continuously and may be checked via the internet.

### SPECIFIC DATA RELATED TO THE INVENTION

This application claims the benefit of U.S. provisional application No. 60/476,064, filed Jun. 5, 2003.

### BACKGROUND OF THE INVENTION

The present invention relates to a method and apparatus for reclaiming spent cooking oil, such as, for example, the oil used in the deep frying machines at fast food restaurants, and in particular to a method and process operable in a mobile refinery such as a semi-trailer.

The disposal of used cooking oil is a major problem today, particularly in the case of fast food restaurants, hospitals and other large producers of fried foods. Such used cooking oil are usually contaminated with particulate food materials, such as potato, chicken, or other food products.

The largest problem with reprocessing spent oil is that it is collected at dispersed locations, such as fast food restaurants, hospitals and other large producers of fried foods. These locations have only small quantities of waste oil on hand. Large refineries have been introduced to meet the need for processing at centralized locations, but such systems are inherently less efficient than mobile processing facilities. Furthermore, waste disposal is a problem, since some of the waste generated from cooking with oil is spilled and mishandled, sometimes in blatant disregard for community law. In some cities, manhole covers are marked; it is understood that grease may be dumped at these locations. The problem is then handled by the local water treatment facility, which is ill-prepared to deal with large quantities of waste grease. It is difficult to determine whether this is an acknowledged or illegal activity. It is impractical, for example, for a septic service, to travel from a centralized location in one truck, retrieve the grease, and travel back to the main office. Shortcuts are taken.

In conventional centralized processing to create bio-diesel fuel, once the grease or used cooking oil is transported to the central refinery and converted to fuel, a second truck must set out on delivery. This increases the cost of transport four times (two truck, two drivers, four trips). It is therefore desirable to provide for a method and apparatus to treat spent oil while in transport from source to delivery site, returning to the main office only to replenish material, or for emergency repair. Various patented processes are known that use chemical conversion to create biodiesel. The prior art discloses the use of waste or virgin oil, mixers, and catalysts.

Currently, state of the art processes do not suggest the incorporation of self-cleaning filtration systems to process used oil and the inherent contaminates. Nor is there any computer controlled system for production of the fuel. It also does not address achieving and warranting any standards set forth by various engine manufactures or committees via automation.

### SUMMARY OF THE INVENTION

This invention describes a mobile process to reclaim spent cooking oil and convert such oil to a biodiesel fuel. The spent oil contains deleterious contaminants, including food particles, and water and emulsified or congealed grease. The present invention removes particulate contaminates and water by passing the oil through a strainer/separator filtration process. Glycerin is then removed by passing through a series of chambers/processes. The reclaimed oil can then be used as biodiesel. The entire process is computer monitored and controlled. Once the used oil is in a collection vessel, it can be sent to one of many (determined by the size of the truck or location) catalyzing vessels for mixing. Each of the collection, catalyzing and washing vessels may be at different stages of transesterification simultaneously.

The filtration and catalyst media are housed in a mobile enclosure, such as a semi-trailer. The mobile trailer may be used at various collection sites for cleaning and reprocessing spent oil. After the filtration and catalyst media are spent, the mobile trailer is then returned to a central processing facility for the efficient regeneration of the filtration and catalyzing media. Centralized regeneration is advantageous in that the waste produced by the filtration is concentrated at a single treatment and disposal facility. The centralized processing facilities can be monitored to ensure compliance with local, state and federal environmental regulations. The process eliminates the need for capital investment for companies that convert oil to biodiesel. The mobile refining process benefits such applications as used cooking, virgin, animal, vegetable and algae based oils. These terms are considered interchangeable as used herein.

Conventional biodiesel refining is energy and capital intensive. The quality of biodiesel is difficult to maintain since impurities are managed in gross quantity. In small processing runs, a chamber that does not meet specification can be easily discarded. If the oil that cannot be processed is added to a large quantity, it may well ruin the entire lot. The present invention preferably handles smaller quantities which can be treated on a regional basis so as to minimize transportation and capital costs. The mobile refinery can be utilized at several locations with minimal turn around time and set-up times, while a centralized processing facility for regenerating the filtration and catalysts provides better economics as well as better control of regenerant wastes.

### BRIEF DESCRIPTION OF THE DRAWINGS

FIG. 1 is a schematic of the process of the present invention.

FIG. 2 is a schematic representing a reaction cell which changes the waste/virgin oil to biodiesel and glycerin.

FIG. 3 is a schematic representing a wash cell which cleans the biodiesel, removing any final impurities.

FIG. 4 is a schematic representing a Main Controller which communicated/coordinates each of the programmable controllers in the individual cells and all truck bound operations.

FIG. 5 is a schematic representing a PC Controller which provides communications to and from the Main Controller and the operator and the centralized depot; and

FIG. 6 is a schematic representing a truck with one complete production line. As determined by need, multiple collection, reaction, and washing cells may be combined to achieve the proper ratio for efficient production.

### DETAILED DESCRIPTION OF THE PREFERRED EMBODIMENTS

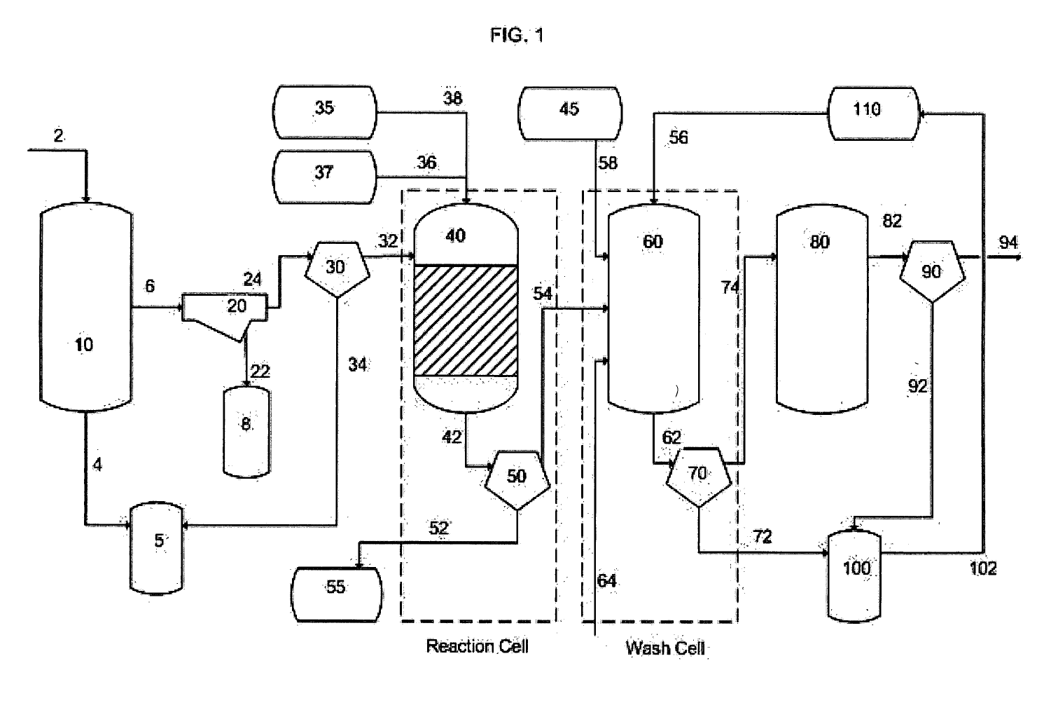

FIG. 1 illustrates one process for reclaiming spent cooking oil, in particular fast food frying grease by changing it chemically into biodiesel and glycerin in a mobile refinery. The process removes particulate contaminants and water. The contaminants are removed by passing through a series of self-cleaning filters and separators. In a particular embodiment, the spent oil passes through a self-cleaning strainer and heating tank, a catalyzing vessel that also titrates the proper amount of catalyst and monitors and removes the accumulated glycerin, a wash vessel that monitors and balances the pH of the biodiesel and cleans the fuel a final time to remove any remaining impurities. After the cleaning process, the fuel is forwarded to the delivery tank. On delivery, the biodiesel is filtered a final time, the amount and specifications of the fuel is logged by a computer. The byproducts are housed within the mobile refinery that can be taken to a central processing facility to allow regeneration of the catalyst and filters and disposal of waste.

Collection vessel 10 serves as a collection reservoir for the used cooking oil 2 introduced to the system. Item 20 separates particulates from the input oil 2. It is desirably a self-cleaning system which includes but is not limited to a strainer. The strainer should consist of a stainless steel membrane having one input 6 and two outputs 24, 22. Settled water from the collected oil is extracted out through drain 4 and filtered and collected in reservoir 5. Output 22 from item 20 removes particulate material and from the collected spent oil. Collected particulate matter 22 from collection vessel 10 is presented to the collection tank 8 for removal at the central facility. Cleaned and heated oil 24 is passed to a ready water/oil separator 30.

The water/oil separator 30 contains a media which absorbs trace water and particulate matter in various micron sizes and bulk water not removed by settling which occurs in the vessel 10. The oil then travels through conduit 32 to the next ready catalyst chamber 40. Excess water trapped by the separator 30 is collected or drained via 34 to waste collection chamber 5.

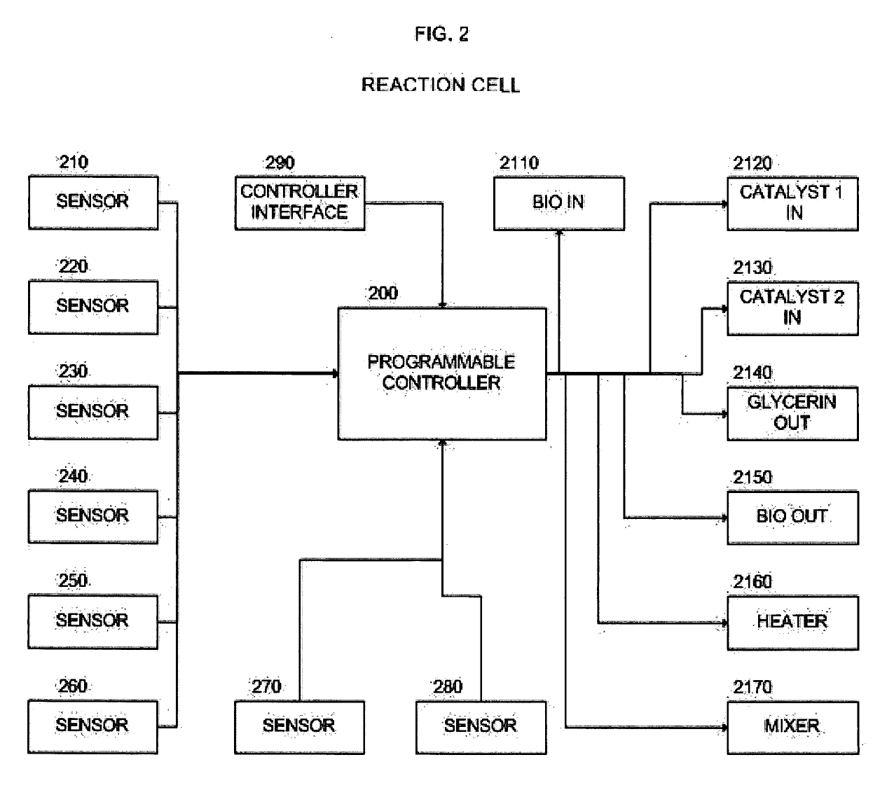

The oil in the reaction chamber (FIG. 2) 40 is monitored and the proper concentration of catalysts 35,37 is titrated via computer. Methanol or ethanol 35 is added to achieve the desired oil to alcohol ratio. Catalyst 37 is added and the combined solutions are mixed. The mixing is timed according to the titration and controlled via computer controller 200. As glycerin is formed a sensor detects its presence; it is drained by applying negative pressure to the base of a oil/water separator 50. A computer controlled valve opens in the presence of glycerin and closes when it is gone. The glycerin is actively drained to holding tank 55 via 52.

Once the computer determines that the fuel is within specification, the liquid travels via 42 through separator 50 then to a wash chamber 60 via 54. The pH is checked and a solution 45 is added to balance at the pH 7.0 via 58. Water from the holding tank 110 is added via 56 and a bubble wash begins. Compressed air is forced in to the bottom of the chamber at a controlled rate 64. After the software determines the fuel sufficiently cleaned, the water is drained via 62 directly to a filtration system 100 and collected for use in the next wash 110. The hose 102 provides transport for the water from the filtration system 100 to the holding tank 110.

The fuel is now sent to the delivery tank via 74. Once on site for delivery, the fuel is delivered from the delivery tank 80 through a final separator 90 via the hose 82. Any excess water from the separator 90 is collected via 92 and sent to the filter 100 and on to the holding tank 110.

In the preferred embodiment of the present invention, the collection tank 10, self-cleaning strainer 20 oil/water separators 30, 50, 70, 90, catalyst tank(s) 35, pH solution tank 45, wash tank(s) 60, water holding tank 110, delivery tank(s) 80, water filtration system 100 and the water holding tank are enclosed within a mobile enclosure 600. The typical mobile enclosure 600 will be a commercial truck with an overall length of about twenty-four (24) feet or longer, a width of about eight and one-half (8½) feet and a height of about thirteen and one-half (13½) feet. Vessels 30, 40, 50, 55 are so constructed to allow for each to be moved into or out of the mobile enclosure 600 with a common forklift truck which allows for sluice in and out for regeneration service. Multiples of vessels 40, 50, can be loaded in the mobile enclosure 600 to provide maximum capacity. Interconnecting piping, hoses and quick connect couplings are located inside the mobile enclosure 600. In a typical application, the spent filter elements from 30,50,70 and 90 may be left at the site where the truck is maintained. At the same time vessels 35,45,100,110 can be replenished with catalyst, pH solution and water. The particulate waste in collection tank 5 and the glycerin holding tank 55 will also be removed.

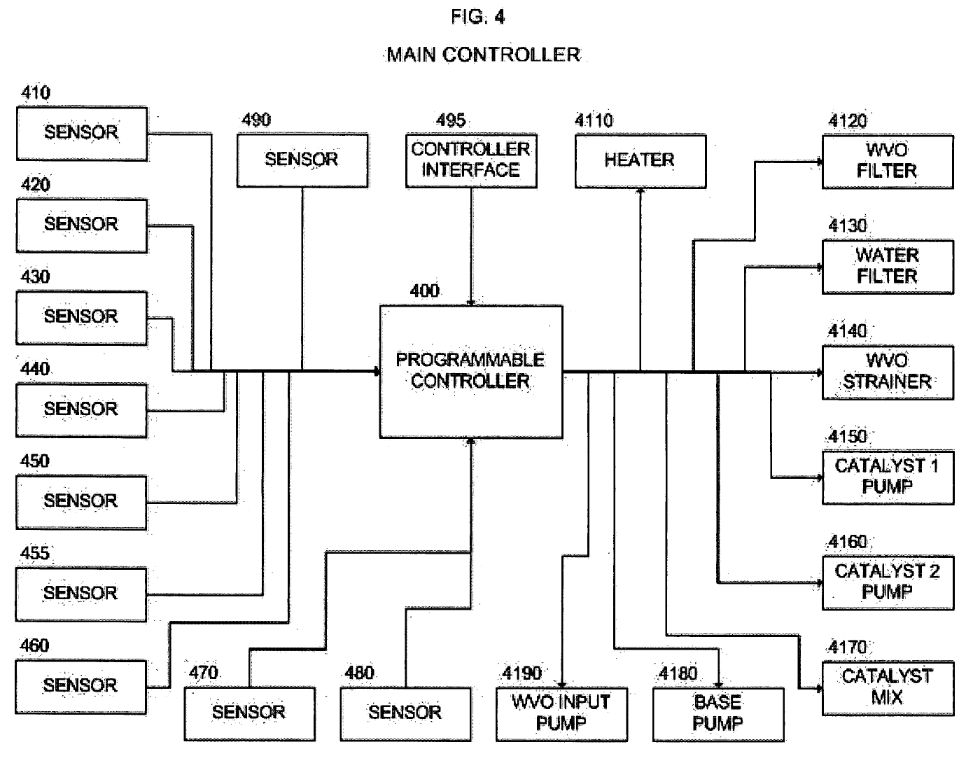

FIG. 2 illustrates an automated reaction cell comprising chamber 40 and separator 50. The programmable controller 200 is monitored by a main controller 400 (FIG. 4) via a controller interface 2290.

Oil entry into and delivery from the cell are managed by the controller 200 and a level sensor 220 and switches 2110, 2150. Once oil enters the reaction cell a programmable controller 200 measures the titration parameters 240 and develops a program for treating the current batch of used or virgin oil. The controller 200 can then measure the temperature 20, and according to the plan of treatment for the current batch, may adjust the temperature via a circuit 2160.

Once the plan is complete the controller can then add catalysts (1 and/or 2) 2120,2130. After delivery of the catalysts the controller 200 will mix the fluids per the plan via a switch 2170. After the mix is finished the controller will wait and monitor the tank for glycerin production 250. Once glycerin formation is detected, the controller will remove the glycerin via a switch operated valve 2140.

The plan is monitored via sensor 280 for quality assurance. Additionally, the oil/water separator pressure is monitored via sensor 230. If the negative pressure limit is exceeded an alarm can be sent to replace the filter. Once specifications are met the plan is complete and the biodiesel is ready to proceed to a wash cell.

The temperature cutoff 270 monitors the status of an independent thermal switch which will remove power from the heater if the temperature in the reaction cell 40 exceeds a predetermined limit. The pressure inside the cell is also closely monitored and should it reach a predetermined point the process will stop 260. The level of fluid is controlled by sensors 220 and may signal a problem if critical levels are reached.

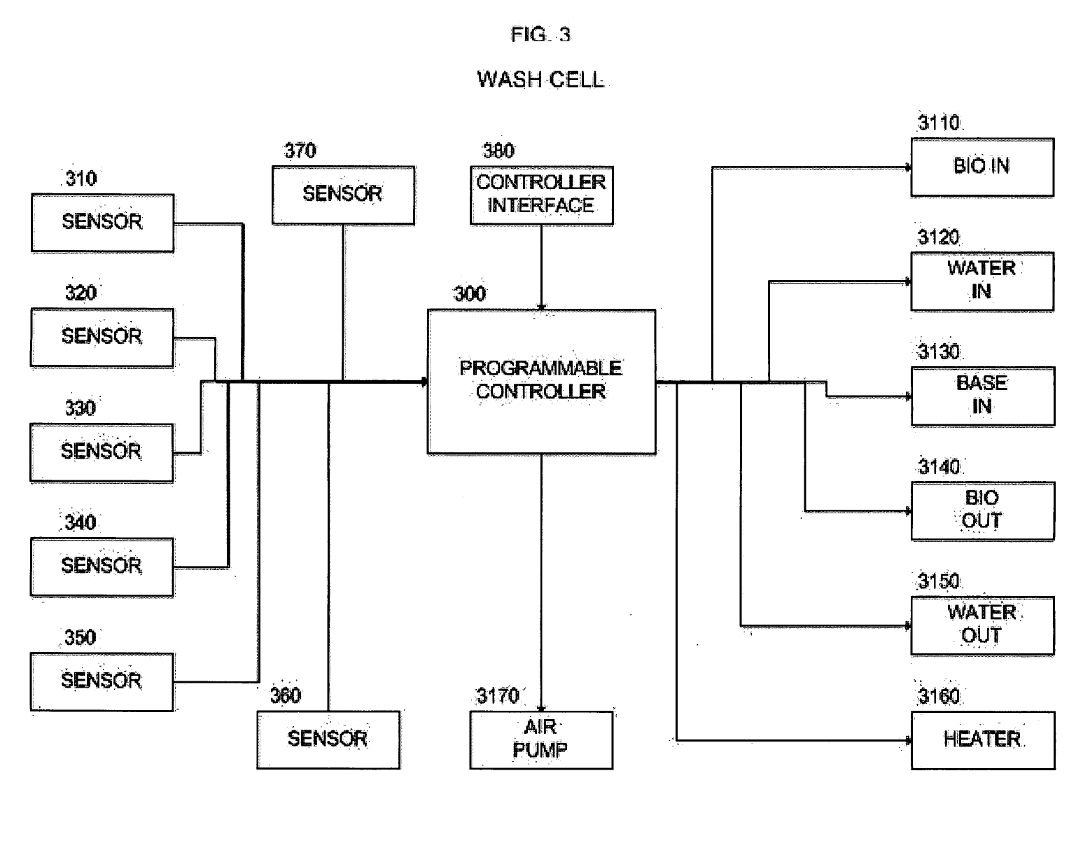

A wash cell comprising elements 60,62,70 used to remove contaminates from the biodiesel is shown in more detail in FIG. 3. The programmable controller 300 is monitored by a main controller 400 (FIG. 4) via a controller interface 2380.

After the reaction cell completes its portion of the plan the biodiesel is delivered to the wash cell. Oil entry into and delivery from the cell are managed by the wash controller 300 and a level sensor 310 and switches 3110, 3140. The biodiesel must be washed in controlled ratios of water to biodiesel. Thus entry of water into and delivery from the cell are managed by the wash controller 300 and a level sensor 310 and switches 3120, 3150. The pH of the fuel is measured by the sensor 320 and if necessary, a managing solution is added by a switched valve controlled by 3130.

Once the mix is in the cell, compressed air is forced into the bottom of the chamber through a switch 3170. As it rises through the water/fuel mix it removes any remaining impurities. The fuel is repeatedly tested via 360. Once in specification the wash is complete. The controller then opens a drain 3150 watching with sensor 350. When the sensor notes that the water is gone the water drain 3150 is closed and the biodiesel out 3140 is opened. The biodiesel is forwarded to the delivery tank through filter/separator 70.

If deemed necessary by the 360 sensor, the fuel can be heated in a final step via 340. The temperature is controlled by a switch 3160.

The temperature cutoff 370 monitors the status of an independent thermal switch which will remove power from the heater if the temperature in the wash cell 60 exceeds a predetermined limit. The pressure inside the cell is also closely monitored and should it reach a predetermined point the process will stop 360. The level of fluid is controlled by sensors 310 and may signal a problem if critical levels are reached.

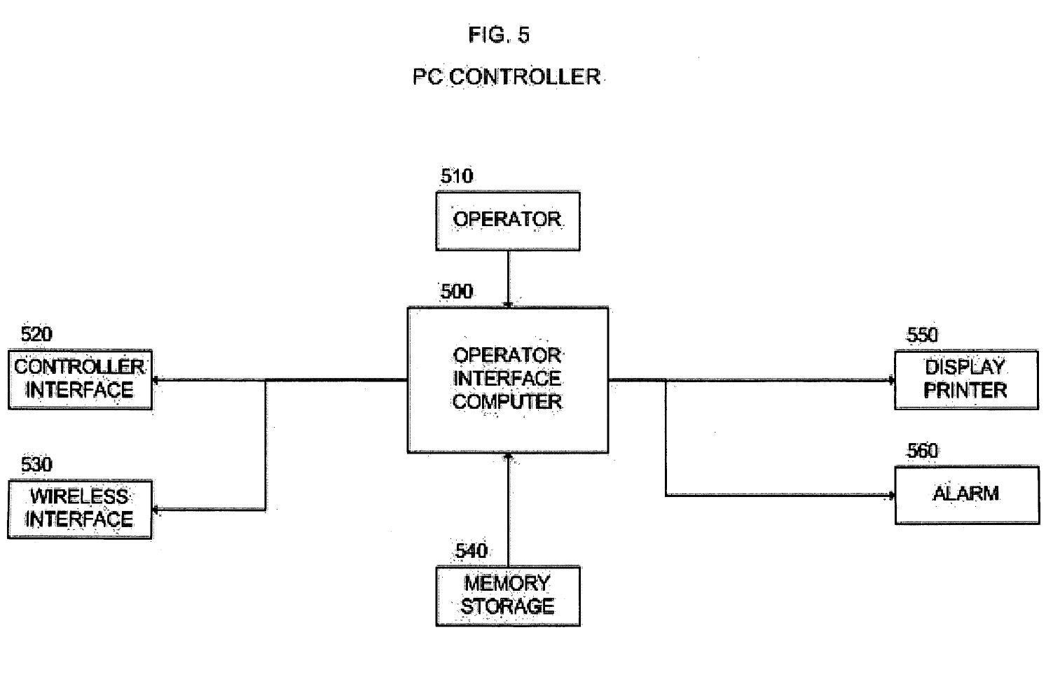

FIG the programmable controller 400 which is monitored and controlled by a PC controller 500 (FIG. 5) via a controller interface 495. The main controller 400 monitors each of the program controllers 200, 300 via their controller interface. Any number of program controllers may be monitored simultaneously. Information forwarded by the program controllers may be transferred to the PC controller 500 shown in FIG. 5.

The main programmable controller 500 is responsible for monitoring the temperature in the waste oil tank via 410. and can adjust the temperature via 4110. Controller 400 also monitors the level of grease in the waste oil tank via 420 and can stop the input pump via 4190.

Controller 400 also monitors the water filter operation via 430. The water filter can be started/stopped by 4130. An operator is notified if parameters become abnormal.

Controller 400 monitors the pressure in the catalyst 1 tank via 440. The level is measured via 470. The pump for the catalyst 1 solution is controlled via 4150. This catalyst may require occasional re-mixing. The controller 400 can initiate mixing via 4140. It will notify the PC controller 500 if parameters become abnormal, or if catalyst is needed.

Controller 400 monitors the pressure in the catalyst 2 tank via 460. The level is measured via 480. The pump for the catalyst 2 solution is controlled via 4160. It will notify the PC controller 500 if parameters become abnormal.

Controller 400 monitors the pressure in the base tank via 450. The level is measured via 455. The pump for the base solution is controlled via 4180. It will notify the PC controller 500 if parameters become abnormal.

Controller 400 monitors the pressure in the waste oil separator via 490. It will notify the PC controller 500 if parameters become abnormal.

Controller 400 controls the self-cleaning strainer for the waste oil 4120. When it decides that the temperature is correct it will pass the waste oil through the strainer to the next (reaction) cell. All communication to and from the Main Controller occurs via controller interfaces in the respective cells.

FIG. 5 shows the PC controller 500 which is illustrated as a personal computer. The operator 510 is notified of any incorrect parameters via the operator interface computer 500. The computer 500 can print reports 550, sound audio and/or visual alarms 560, and communicate with the central office and store data 540. The controller interface 520 provides the all the cells controller interfaces such as 290, 390. The wireless interface 530 provides communication between a centralized maintenance depot and the truck. This depot is notified when the truck is depleted, broken or otherwise out of specification.

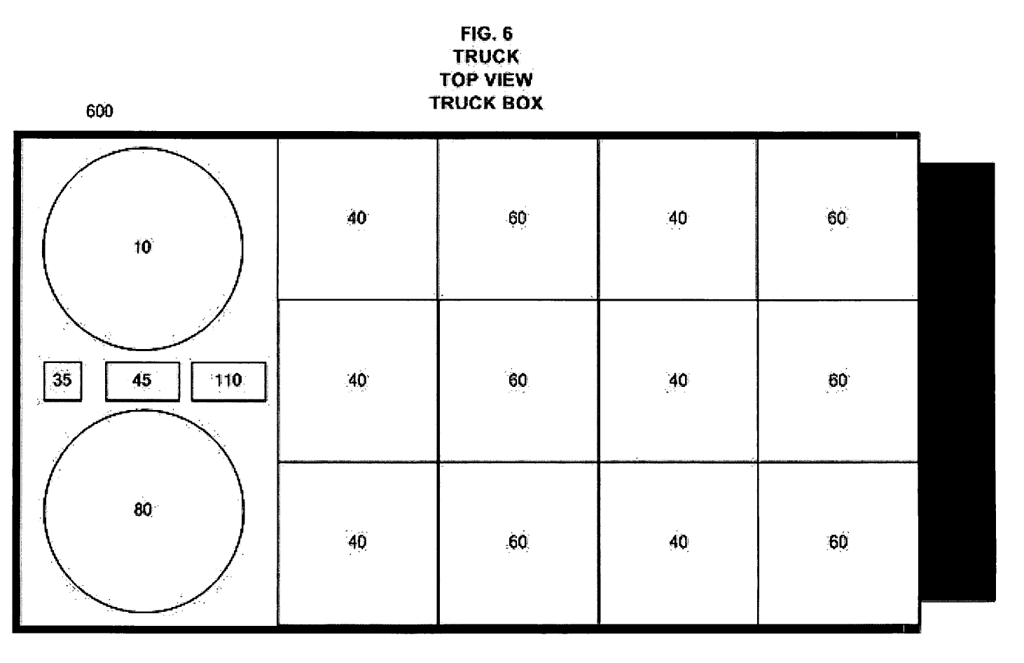

FIG. 6 is a schematic representing a truck 600 with multiple production lines. As determined by need, various collection, delivery (10,80) reaction (40), and washing cells (60) may be combined to achieve the proper ratio for efficient production. The catalyst (35,45) and water (110) tanks are also shown.

1. A mobile refinery for converting used cooking oil to a fuel for use in a diesel engine comprising:
a semi-truck trailer;
a collection vessel mounted in the trailer for receiving used cooking oil;
a filtering system for removing contaminants from the cooking oil;
a separator for extracting glycerin from the cooking oil;
a reaction chamber for introducing alcohol into the cooking oil; and
a computer controller for regulating the flow of oil through the refinery.

2. The mobile refinery of claim 1 and including a wash chamber for cleaning the cooking oil after conversion to fuel in the reaction chamber.

3. The mobile refinery of claim 2 and including a pH balance system for monitoring and adjusting the pH of the converted fuel.

4. The mobile refinery of claim 3 and including a delivery tank for storing converted fuel on the trailer.
